(19) United States
(12) Patent Application Publication
(10) Pub. No.: US 2014/0016062 A1
(43) Pub. Date: Jan. 16, 2014

(54) LIQUID CRYSTAL DISPLAY DEVICE

(71) Applicant: Kazuya Hatta, Yonago-shi (JP)

(72) Inventor: Kazuya Hatta, Yonago-shi (JP)

(73) Assignee: SHARP KABUSHIKI KAISHA, Osaka (JP)

(21) Appl. No.: 14/007,908

(22) PCT Filed: Apr. 2, 2012
(86) PCT No.: PCT/JP2012/058869

§ 371 Date: Sep. 26, 2013

(30) Foreign Application Priority Data
Apr. 6, 2011 (JP) 2011-084317

(51) Int. Cl. G02F 1/1333

(52) U.S. Cl. CPC G02F 1/133308
USPC 349/58

(57) ABSTRACT

A liquid crystal display device is provided with: a liquid crystal display panel (120); a front bezel (110) located on the display surface side of the liquid crystal display panel (120) and having an opening (111) in the side wall thereof; and a rear bezel (132) located on a side of the liquid crystal display panel (120) opposite to the display surface side and having on the sidewall thereof a tab (131) engaging the opening (111). The liquid crystal display device is also provided with an elastic body (140) that is located between the front bezel (110) and the rear bezel (131) and that, in a state in which the opening (111) and the tab (131) engage each other, pushes the front bezel (110) and the rear bezel (132) in the respective directions further away from each other. The elastic body (140) is made of a plurality of elastic members (141, 142) that have different elastic moduli.

### TECHNICAL FIELD

The present invention relates to a liquid crystal display device.

### BACKGROUND ART

Japanese Patent Application Laid-Open Publication No. H7-281184 (Patent Document 1) is a prior art document that discloses a liquid crystal display device provided with a rubber cushion for securely pressing a light guide plate and a liquid crystal display panel inside the device.

In the liquid crystal display device described in Japanese Patent Application Laid-Open Publication No. H7-281184 (Patent Document 1), side edges of a diffusion sheet and a prism sheet disposed on the upper surface of the light guide plate protrude beyond respective ends of the light guide plate and are placed on side walls of a rear bezel. A front bezel and the rear bezel are assembled together by having lock receiving parts of the front bezel and locking parts of the rear bezel engage each other, in a state in which rubber cushions are provided between the side walls of the rear bezel and a lower surface of an upper transparent glass substrate of the liquid crystal display panel, with the diffusion sheet and the prism sheet interposed therebetween.

### RELATED ART DOCUMENT

### Patent Document

Patent Document 1: Japanese Patent Application Laid-Open Publication No. H7-281184

### SUMMARY OF THE INVENTION

### Problems to be Solved by the Invention

When sandwiching the liquid crystal display panel between the front bezel and the rear bezel through rubber cushions by having the lock receiving parts of the front bezel and the locking parts of the rear bezel engage each other, if a gap greater than a contraction length of the rubber cushions exists between the lock receiving parts of the front bezel and the locking parts of the rear bezel, the rubber cushions cannot fulfill the function thereof.

The present invention was made in view of the above-mentioned problem, and an object thereof is to provide a liquid crystal display device in which a front bezel and a rear bezel can be assembled together more reliably while allowing a greater gap to be provided between a lock receiving part of the front bezel and a locking part of the rear bezel.

### Means for Solving the Problems

A liquid crystal display device of the present invention includes: a liquid crystal display panel; a front bezel positioned on a display surface side of the liquid crystal display panel, the front bezel having a lock receiving part in a side wall thereof; and a rear bezel positioned on a side of the liquid crystal display panel opposite to the display surface side, the rear bezel having, on a side wall thereof, a locking part that engages the lock receiving part. The liquid crystal display device further includes an elastic body disposed between the front bezel and the rear bezel, the elastic body pushing the front bezel and the rear bezel in respective directions further away from each other in a state in which the lock receiving part and the locking part engage each other. The elastic body is made of a plurality of elastic members having different elastic moduli.

It is preferable that the plurality of elastic members be a rubber member and a porous member that is made of a resin having a lower elastic modulus than that of the rubber member.

It is preferable that the porous member be a sponge.

In one embodiment of the present invention, the elastic body is configured such that the rubber member covers outer surfaces of the porous member.

In one embodiment of the present invention, the elastic body has a three-layer structure in which the rubber member sandwiches the porous member.

In one embodiment of the present invention, the liquid crystal display device includes a plurality of elastic bodies. The front bezel has a plurality of lock receiving parts. The rear bezel has a plurality of locking parts. The plurality of elastic bodies are respectively positioned near the plurality of lock receiving parts and the plurality of locking parts.

### Effects of the Invention

According to the present invention, it is possible to more reliably assemble the front bezel and the rear bezel together while allowing a greater gap to be provided between a lock receiving part of the front bezel and a locking part of the rear bezel.

### BRIEF DESCRIPTION OF THE DRAWINGS

FIG. 1 is an exploded perspective view showing a configuration of a liquid crystal display device according to Embodiment 1 of the present invention.

FIG. 2 is a perspective view showing an exterior of the liquid crystal display device of Embodiment 1.

FIG. 3 is a partial cross-sectional view along the line III-III of FIG. 2, viewed from the direction of the arrows.

FIG. 4 is a cross-sectional view showing a state in which an elastic body of Embodiment 1 is sandwiched and thus deformed.

FIG. 5 is a partial cross-sectional view of a liquid crystal display device of Comparison Example along the line III-III of FIG. 2, viewed from the direction of the arrows.

FIG. 6 is a cross-sectional view schematically showing an effect of the elastic body of Embodiment 1.

FIG. 7 is an exploded perspective view showing a configuration of a liquid crystal display device according to Embodiment 2 of the present invention.

FIG. 8 is a cross-sectional view showing a structure of an elastic body of Embodiment 2.

FIG. 9 is a cross-sectional view showing a structure of an elastic body of Modification Example 1 of Embodiment 2.

FIG. 10 is a cross-sectional view showing a structure of an elastic body of Modification Example 2 of Embodiment 2.

FIG. 11 is a cross-sectional view showing a structure of an elastic body of Modification Example 3 of Embodiment 2.

### DETAILED DESCRIPTION OF EMBODIMENTS

Below, a liquid crystal display device of Embodiment 1 of the present invention will be explained. In the descriptions for embodiments below, the identical or corresponding portions in the respective drawings are given the same reference characters, and descriptions thereof will not be repeated.

### Embodiment 1

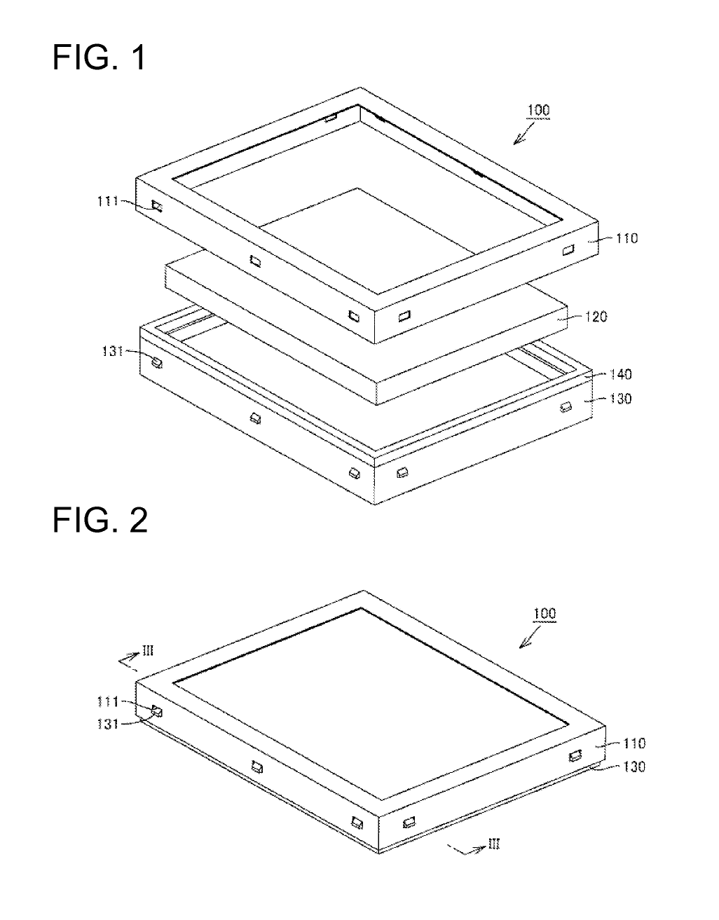

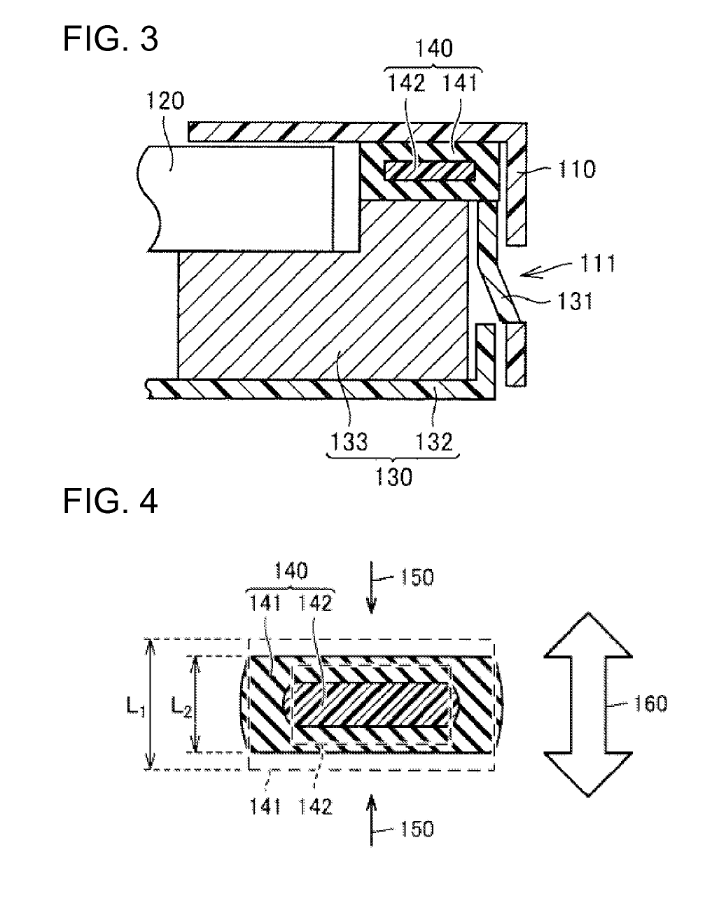

FIG. 1 is an exploded perspective view that shows a configuration of a liquid crystal display device of Embodiment 1 of the present invention. FIG. 2 is a perspective view that shows an exterior of the liquid crystal display device of the present embodiment. FIG. 3 is a partial cross-sectional view along the line III-III of FIG. 2, viewed from the direction of the arrows.

As shown in FIGS. 1 to 3, a liquid crystal display device 100 of Embodiment 1 of the present invention includes a liquid crystal display panel 120, a front bezel 110, and a backlight unit 130. The liquid crystal display panel 120 is disposed between the front bezel 110 and the backlight unit 130.

The front bezel 110 is positioned on a display surface side of the liquid crystal display panel 120, and has a rectangular open portion in a position corresponding to the display surface of the liquid crystal display panel 120. The front bezel 110 has a plurality of openings 111, which are lock receiving parts, in side walls thereof. The openings 111 have a rectangular shape in a side view.

The backlight unit 130 has a rear bezel 132, and a frame 133 and a not-shown light guide body housed inside the rear bezel 132, and the like.

The rear bezel 132 is positioned on a side of the liquid crystal display panel 120 opposite to the display surface, and has, on side walls thereof, tabs 131 as locking parts that engage the openings 111 of the front bezel 110. The tabs 131 are formed by making portions of side walls of the rear bezel 132 protrude from the outer surfaces of the side walls.

The frame 133 is fixed to the bottom part of the rear bezel 132. A not-shown light guide body, LEDs (light-emitting diodes) that are light sources, and the like are attached to the frame 133.

The front bezel 110 is placed on the rear bezel 132 such that the inner surfaces of the side walls of the front bezel 110 face the outer surfaces of the side walls of the rear bezel 132. By the tabs 131 of the rear bezel 132 engaging the openings 111 of the front bezel 110, the front bezel 110 and the rear bezel 132 are assembled together.

In the present embodiment, an elastic body 140 is positioned between a periphery of the open portion in the front bezel 110, and a portion of the frame 133 and a portion of the rear bezel 132 respectively facing the periphery. In other words, the elastic body 140 is positioned between the front bezel 110 and the rear bezel 132.

The elastic body 140 has a frame shape, and is positioned so as to surround the open portion of the front bezel 110. The elastic body 140 has an exterior shape with a rectangular cross section. In the present embodiment, the elastic body 140 is fixed to the portion of the frame 133 and the portion of the rear bezel 132 respectively facing the periphery by using a double-sided tape. However, the elastic body 140 may also be bonded to the periphery of the open portion of the front bezel 110.

The elastic body 140 pushes the front bezel 110 and the rear bezel 132 in respective directions further away from each other in a state in which the openings 111 of the front bezel 110 and the tabs 131 of the rear bezel 132 engage each other.

The elastic body 140 is made of a plurality of elastic members that have different elastic moduli. In the present embodiment, the elastic body 140 is constituted of a rubber member 141 and a sponge 142. The sponge 142 is a porous member made of a resin that has a lower elastic modulus than that of the rubber member 141. Specifically, the rubber member 141 covers outer surfaces of the sponge 142.

However, the elastic body 140 is not limited to the above-mentioned configuration, and any configuration may be employed as long as the elastic body 140 includes an elastic member with a higher elastic modulus that can provide an urging force, and an elastic member with a lower elastic modulus that can provide deformability. The porous member made of a resin is not limited to a sponge, and may be an elastic member that has a lower elastic modulus than that of the rubber member 141.

FIG. 4 is a cross-sectional view showing a state in which the elastic body of the present embodiment is sandwiched and thus deformed. As shown in FIG. 4, when the elastic body 140 having a length L₁ in the short side direction receives an external force 150 from top and bottom in the short side direction of the elastic body 140, the elastic body 140 elastically deforms and contracts, thereby having a length L₂. At this time, the elastic body 140 has a reactive force 160, which acts as an urging force.

The contraction length (L₁−L₂) of the elastic body 140, which is caused by the external force 150 of a certain strength, is determined by the elastic moduli of the rubber member 141 and the sponge 142, a ratio of the volume of the rubber member 141 to the volume of the sponge 142, the shapes of the rubber member 141 and the sponge 142, and the like.

For example, the length L₁ of the elastic body 140 in the short side direction is set to 3.25 mm, the length of the sponge 142 in the short side direction is set to 0.85 mm, and the contraction length (L₁−L₂) of the elastic body 140 is set to 1.7 mm. The hardness of the rubber member 141 is approximately 40.

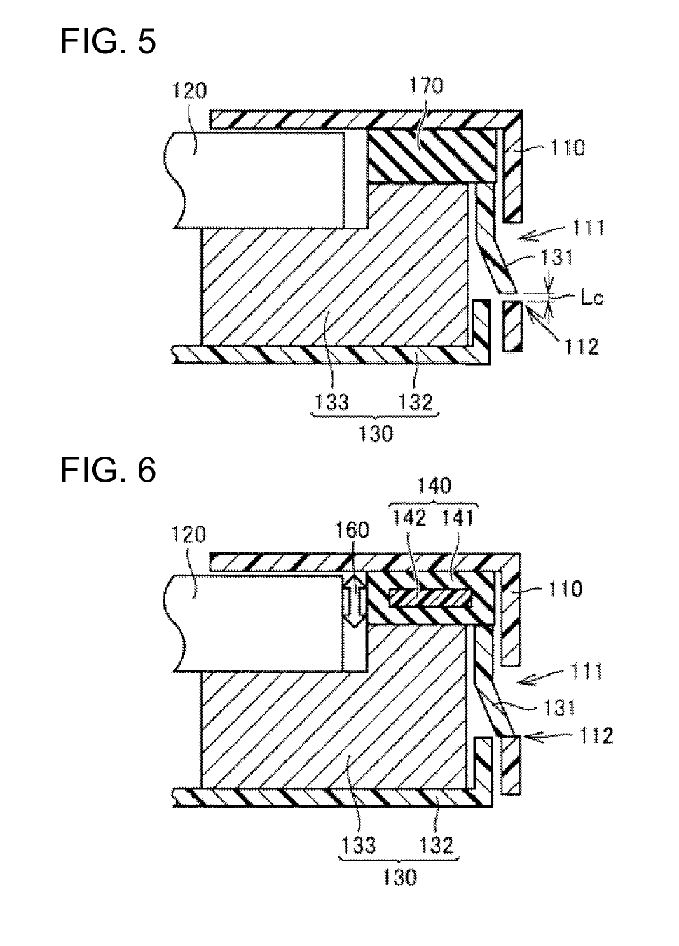

FIG. 5 is a partial cross-sectional view of a liquid crystal display device of Comparison Example along the line III-III of FIG. 2, viewed from the direction of the arrows. As shown in FIG. 5, in the liquid crystal display device of Comparison Example, an elastic body 170 having the same exterior shape as the elastic body 140 and made of a rubber member only is disposed between the front bezel 110 and the rear bezel 132, instead of the elastic body 140.

The elastic modulus of the elastic body 170 made of the rubber member is higher than the elastic modulus of the elastic body 140 of the present embodiment. Therefore, the elastic body 170 is less susceptible to deformation than the elastic body 140. Specifically, the contraction length of the elastic body 170, which is caused by the external force 150, is shorter than the contraction length (L₁−L₂) of the elastic body 140 when receiving the external force 150.

The relative positional relationship between an edge 112 of the opening 111 of the front bezel 110 and the tab 131 of the rear bezel 132 has certain variations as a result of dimensional errors of the front bezel 110 and the rear bezel 132.

Therefore, when the gap between the edge 112 of the opening 111 and the tab 131 is greater than the contraction length of the elastic body 170, as shown in FIG. 5, a gap having a length Lc can be left between the edge 112 of the opening 111 and the tab 131. In such a case, the elastic body 170 cannot provide an urging force.

FIG. 6 is a cross-sectional view schematically showing an effect of the elastic body of the present embodiment. As shown in FIG. 6, in the present embodiment, the elastic body 140 having a greater contraction length is provided, and therefore, it is possible to allow a greater gap to be formed between the edge 112 of the opening 111 of the front bezel 110 and the tab 131 of the rear bezel 132.

This way, with the reactive force 160, the front bezel 110 and the rear bezel 132 can be pushed in respective directions further away from each other, and as a result, it is possible to prevent a gap between the edge 112 of the opening 111 and the tab 131 from being created. Thus, as compared with the liquid crystal display device of Comparison Example, in the liquid crystal display device 100 of the present embodiment, the front bezel 110 and the rear bezel 132 can be assembled together more reliably.

As a result, the mechanical rigidity of the liquid crystal display device 100 is increased, and therefore, the durability of the liquid crystal display device 100 is improved.

In the present embodiment, the openings 111 are provided as lock receiving parts of the front bezel 110, and the tabs 131 are provided as locking parts of the rear bezel 132, but tabs may be formed in the front bezel 110 as locking parts, and openings may be formed in the rear bezel 132 as lock receiving parts. If the frame 133 doubles as the rear bezel 132, the locking parts are provided in the frame 133.

Below, a liquid crystal display device of Embodiment 2 of the present invention will be explained. A liquid crystal display device 200 of the present embodiment differs from the liquid crystal display device 100 of Embodiment 1 only in the shape and number of the elastic body, and therefore, the descriptions for other configurations are not repeated.

### Embodiment 2

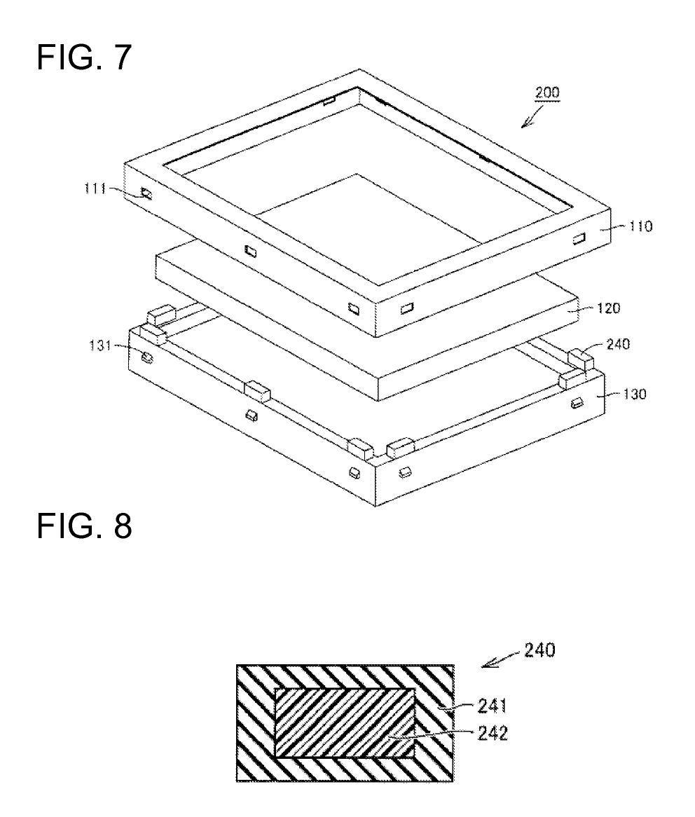

FIG. 7 is an exploded perspective view that shows a configuration of a liquid crystal display device of Embodiment 2 of the present invention. As shown in FIG. 7, the liquid crystal display device 200 of Embodiment 2 of the present invention includes a plurality of elastic bodies 240. The front bezel 110 has a plurality of openings 111. The rear bezel 132 has a plurality of tabs 131. The plurality of elastic bodies 240 are positioned adjacent to the plurality of openings 111 and the plurality of tabs 131, respectively. Specifically, the elastic bodies 240 are located above the tabs 131 of the rear bezel 132, respectively. The elastic bodies 240 each have a rectangular cuboid shape.

FIG. 8 is a cross-sectional view showing a structure of an elastic body of the present embodiment. As shown in FIG. 8, the elastic body 240 has an exterior shape with a rectangular cross section. A sponge 242 has an exterior shape with a rectangular cross section.

The elastic body 240 pushes the front bezel 110 and the rear bezel 132 in respective directions further away from each other in a state in which the openings 111 of the front bezel 110 and the tabs 131 of the rear bezel 132 engage each other.

The elastic body 240 is made of a plurality of elastic members that have different elastic moduli. In the present embodiment, the elastic body 240 is constituted of a rubber member 241 and the sponge 242. The sponge 242 is a porous member made of a resin that has a lower elastic modulus than that of the rubber member 241. Specifically, the rubber member 241 covers outer surfaces of the sponge 242. The sponge 242 is not covered by the rubber member 241 in a portion of a side face of the elastic body 240, thereby being exposed.

However, the elastic body 240 is not limited to the above-mentioned configuration, and any configuration may be employed as long as the elastic body 240 includes an elastic member with a higher elastic modulus that can provide an urging force, and an elastic member with a lower elastic modulus that can provide deformability. The porous member made of a resin is not limited to a sponge, and may be an elastic member that has a lower elastic modulus than that of the rubber member 241.

In the liquid crystal display device 200 of the present embodiment, the size of the elastic body 240 can be made smaller than the elastic body 140 of the liquid crystal display device 100 of Embodiment 1, and therefore, it is possible to reduce the device cost by reducing an amount of the elastic member to be used.

Also, because the sponge 242 is exposed, when the elastic body 240 contracts, air included in the sponge 242 can be released to the outside, thereby making it possible to reduce the resistance to deformation in the elastic body 240. Thus, a force required for locking the front bezel 110 and the rear bezel 132 together can be reduced, which makes it easier to assemble the liquid crystal display device 200.

Furthermore, because the elastic body 240 can be disposed in a portion of the liquid crystal display device 200, the same elastic body 240 can be commonly used in a plurality of liquid crystal display devices having display screens of different sizes. Because the same parts can be used for different devices, the manufacturing cost can be reduced.

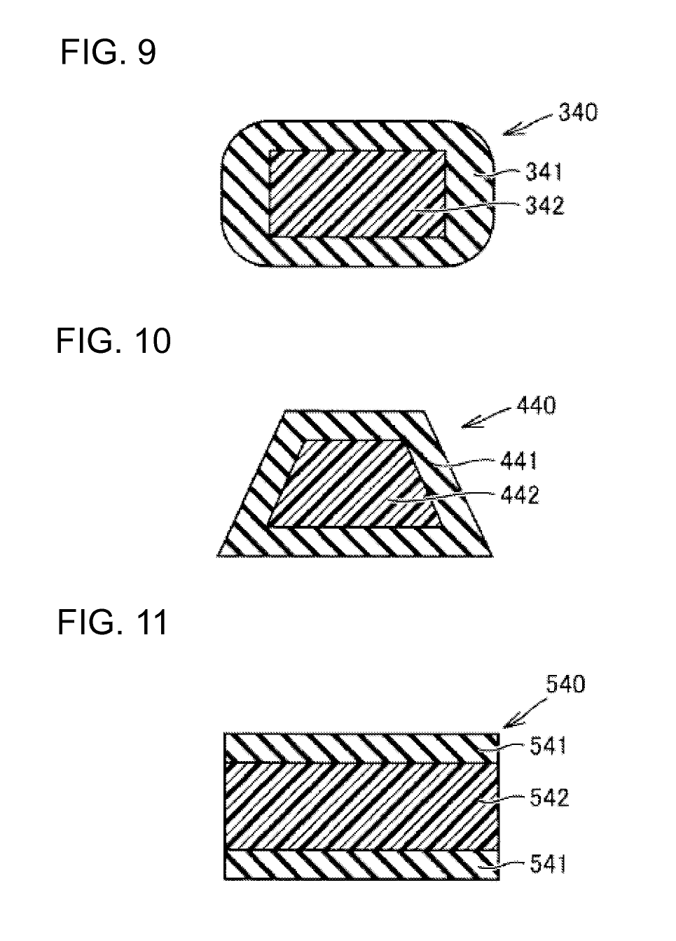

FIG. 9 is a cross-sectional view showing a structure of an elastic body of Modification Example 1 of the present embodiment. FIG. 10 is a cross-sectional view showing a structure of an elastic body of Modification Example 2 of the present embodiment. FIG. 11 is a cross-sectional view showing a structure of an elastic body of Modification Example 3 of the present embodiment.

As shown in FIG. 9, an elastic body 340 of Modification Example 1 of the present embodiment has an exterior shape with an oval-shaped cross section. A sponge 342 has an exterior shape with a rectangular cross section. A rubber member 341 covers outer surfaces of the sponge 342. The elastic body 340 has a smaller resistance to deformation upon contraction as compared to the elastic body 240 having an exterior shape with a rectangular cross section. Thus, a force required for locking the front bezel 110 and the rear bezel 132 together can be reduced, which makes it easier to assemble the liquid crystal display device 200.

As shown in FIG. 10, an elastic body 440 of Modification Example 2 of the present embodiment has an exterior shape with a trapezoidal cross section. A sponge 442 has an exterior shape with a trapezoidal cross section. A rubber member 441 covers outer surfaces of the sponge 442. The elastic body 440 has a smaller resistance to deformation upon contraction as compared to the elastic body 240 having an exterior shape with a rectangular cross section. Thus, a force required for making the front bezel 110 and the rear bezel 132 engage each other can be reduced, which makes it easier to assemble the liquid crystal display device 200.

As shown in FIG. 11, an elastic body 540 of Modification Example 3 of the present embodiment has an exterior shape with a rectangular cross section. A sponge 542 has an exterior shape with a rectangular cross section. The elastic body 540 has a three-layer structure in which a rubber member 541 sandwiches the sponge 542. The sponge 542 and the rubber member 541 are bonded to each other through an adhesive or welding. The elastic body 440 has a smaller resistance to deformation upon contraction as compared to the elastic body 240. Thus, a force required for making the front bezel 110 and the rear bezel 132 engage each other can be reduced, which makes it easier to assemble the liquid crystal display device 200. The elastic body 540 can be made more easily than an elastic body in which a rubber member covers outer surfaces of a sponge.

Modification Examples above can also be applied to the liquid crystal display device 100 of Embodiment 1.

The embodiments disclosed herein are examples in every respect and are not limiting. The scope of the present invention is defined by the claims, not by the descriptions above, and all modifications with the same meaning as the claims and within the scope defined thereby are included.

### DESCRIPTION OF REFERENCE CHARACTERS

100, 200 liquid crystal display device

110 front bezel

111 opening

112 edge

120 liquid crystal display panel

130 backlight unit

131 tab

132 rear bezel

133 frame

140, 170, 240, 340, 440, 540 elastic body

141, 241, 341, 441, 541 rubber member

142, 242, 342, 442, 542 sponge

1. A liquid crystal display device, comprising:
a liquid crystal display panel;
a front bezel positioned on a display surface side of the liquid crystal display panel, the front bezel having a lock receiving part in a side wall thereof;
a rear bezel positioned on a side of the liquid crystal display panel opposite to the display surface side, the rear bezel having, on a side wall thereof, a locking part that engages the lock receiving part; and
an elastic body disposed between the front bezel and the rear bezel, the elastic body pushing the front bezel and the rear bezel in respective directions further away from each other in a state in which the lock receiving part and the locking part engage each other,
wherein the elastic body includes a plurality of elastic members having different elastic moduli.

2. The liquid crystal display device according to claim 1, wherein the plurality of elastic members include a rubber member and a porous member, the porous member being made of a resin that has a lower elastic modulus than that of the rubber member.

3. The liquid crystal display device according to claim 2, wherein the porous member is a sponge.

4. The liquid crystal display device according to claim 2, wherein, in the elastic body, the rubber member covers outer surfaces of the porous member.

5. The liquid crystal display device according to claim 2, wherein the elastic body has a three-layer structure in which the rubber member sandwiches the porous member.

6. The liquid crystal display device according to claim 1, comprising a plurality of said elastic bodies,
wherein the front bezel has a plurality of said lock receiving parts,
wherein the rear bezel has a plurality of said locking parts, and
wherein the plurality of elastic bodies are respectively positioned adjacent to the plurality of lock receiving parts and the plurality of locking parts.
